(19) United States
(12) Patent Application Publication
(10) Pub. No.: US 2022/0258184 A1
(43) Pub. Date: Aug. 18, 2022

(54) A FLEXIBLE FILM FLUID-DISPENSING LINER MEMBER

(71) Applicant: Dow Global Technologies LLC, Midland, MI (US)

(72) Inventors: Luca Guj, Horgen (CH); Colmar Wocke, Horgen (CH); Mirella Coroneo, Correggio (IT); Vanni Parenti, Campagnola (IT)

(21) Appl. No.: 17/597,612

(22) PCT Filed: Sep. 1, 2020
(86) PCT No.: PCT/US2020/048886

§ 371 Date: Jan. 13, 2022

(30) Foreign Application Priority Data
Sep. 6, 2019 (IT) 102019000015716

(51) Int. Cl. B05B 1/14; B32B 3/26; B32B 7/12; B32B 27/08; B32B 27/36; B32B 27/32; B32B 37/06; B32B 37/12

(52) U.S. Cl. CPC B05B 1/14; B32B 3/26; B32B 7/12; B32B 27/08; B32B 27/36; B32B 27/32; B32B 2309/02; B32B 37/12; B32B 2250/02; B32B 2250/04; B32B 2250/40; B32B 2307/714; B32B 2307/31; B32B 37/06

(57) ABSTRACT

A multilayer flexible film fluid-dispensing liner member useful for making a dispensing device, the multilayer flexible film fluid-dispensing liner member including: (a) at least a first film substrate layer; and (b) at least a second film substrate layer; wherein at least a portion of the first film substrate layer is bonded to the second film substrate layer forming the multilayer flexible film member; and (c) at least one duct having at least one inlet and a plurality of outlets, the at least one duct being disposed between the first and second substrate layers for forming a path for a fluid to pass from the at least one inlet of the duct to the plurality of outlets of the duct; wherein the first and second substrate layers of the multilayer flexible film fluid-dispensing liner member are constructed of a material that is flexible; and wherein the multilayer flexible film fluid-dispensing liner member has a flexibility property of from 3.6e Nm to 2 Nm; and a process of manufacturing the multilayer flexible film member.

### FIELD

The present invention relates to a flexible film fluid-dispensing liner member and a process of making such flexible film member. The flexible film fluid-dispensing liner member can be used, for example, for making a flexible film fluid-dispensing device for dispensing a fluid.

### BACKGROUND

Polymeric foams, in particular polyurethane foams, are well known. In general, the preparation of a polyurethane foam requires the mixing of reactive chemical components, such as a polyol and an isocyanate, in the presence of normally used additives such as a suitable catalyst, a surfactant or cell growth control agent, and a physical and/or chemical blowing agent which permits the blowing of the foam.

In a continuous process for producing a rigid foam, and particularly in the production of rigid foams for manufacturing a foam panel structure, as currently practiced on conventional machines, it is common practice to spread or pour, via a dispenser or dispensing device, a thin layer of a reactive mixture of the foam-forming components, in a liquid state, inbetween a bottom (or lower) sheet substrate (one outer layer) and a top (or upper) sheet substrate (another outer layer) while the sheet substrates are moving for example in a lateral direction (i.e., in a horizontal plane direction).

Then, as the reactive mixture moves laterally with the bottom sheet substrate, the foam is allowed to start to rise freely, due to the reaction between the chemical components and the effect of the blowing agent, until the expansion of the foam reaches and contacts the top sheet substrate; and the foam forms a panel structure integrally attached to the top sheet substrate and the bottom sheet substrate. The foam in the panel structure is then allowed to cure; and thereafter, the panel structure is cross-sawn into panels. The foam composite panel structure typically includes, for example, a polyurethane resin (PUR) foam core or a polyisocyanurate resin (PIR) foam core. The foam core and outer layers of the panel often are also called sandwich elements or sandwich panels. A common process for the production of a composite panel structure composed of metallic outer layers (also referred to as “facers”) with a core of foam, as generally described above, includes for example, a double band lamination (DBL) process. And, depending on the type of facer on the panel, DBL can be distinguished in rigid-faced DBL (RFDBL) and flexible-faced DBL (FFDBL).

As aforementioned, the DBL process apparatus includes: (1) a lower moving sheet of a desired substrate; (2) an upper sheet of a desired substrate; and (3) a dispenser for applying a reactive foam-forming composition, which can be an emulsion, onto the lower moving sheet of the apparatus. And in general, the DBL process includes the steps of: (I) providing a reactive foam-forming composition by mixing: (a) a polyol mixture, containing polyols, catalysts, additives and gases, i.e. blowing and nucleation agents, with (b) an isocyanate, to obtain a reactive emulsion wherein the reacting liquids in the emulsion ultimately react to form the final PUR foam or PIR foam inbetween the upper (top) and lower (bottom) sheet substrates; and (II) distributing the above obtained emulsion onto the lower moving sheet of the DBL process equipment via a dispenser (also referred to as the “lay down” step). As the emulsion is distributed on the lower sheet substrate, the gases (blowing and nucleating agents) nucleate and expand via bubbles leading to the formation of the final foam that fills the gap between the two sheets, which are confined inside the double band. A dispenser means, device, or apparatus is used to distribute the PUR or PIR emulsion mixture throughout the lower moving sheet width where the foam reacts and polymerizes between the lower and upper sheets. In a short time, the foam cures to form an integral multi-layer (e.g., a three-layer) foamed panel structure. Then, the formed multilayer foamed structure is cut into blocks or sections (or “panels”) of the desired length to form the panel products.

Using a RFDBL process requires that the dispenser or dispensing device used in the process satisfy a strict set of requirements including, for example: (1) a good quality of the top surface wherein the dispenser has to provide a uniform distribution of the foam-forming reactive mixture through the panel width leading to a good aesthetic quality of the top facing sheet substrate; (2) a good working dispenser with a long operational life to provide fewer stops of a continuous process. In general. a normal operational life requirement for the dispenser is half a production shift, i.e. approximately (˜) 4 hours (hr). The operational life of the dispenser is mainly driven by fouling of the reactive mixture that partially or completely obstructs the flow within the dispenser ducts or passageways; (3) a good flexibility wherein the dispenser can serve a broad range of emulsion viscosities and flow rates; and (4) a lower dispenser cost since the dispenser article is an additional cost and such cost needs to be kept low given the fact that these devices are disposable and the current lifetime is around 4 hr.

Heretofore, a rigid solid dispensing device (also referred to as a “rake” or a “poker”) has been used to distribute a foam-forming fluid in a conventional injection molding process to make a foam product. Developments in the field of manufacturing a foam panel typically are directed only to the geometry of a dispensing device and not to technology directed to the fabrication of the dispensing device. In addition, the problem of dispenser lifetime is not addressed by the prior art. Instead, the focus of the prior art is achieving a good distribution or to decrease defects of the foam surface after the laydown step of the process. It is desired therefore to provide a flexible film member that can be used in fabricating a dispensing device suitable for dispensing a reactive fluid composition such a foam-forming fluid reaction composition.

### SUMMARY

The present invention is directed to a novel flexible film fluid-dispensing liner member that can be used to make a flexible film fluid-dispensing apparatus or device suitable for dispensing a reactive fluid composition such as a polyurethane foam-forming fluid reaction composition. The flexible film fluid-dispensing device can then be used in a production line and process for manufacturing a rigid foam multilayer panel article (structure or member).

The flexible film fluid-dispensing liner member of the present invention is also interchangeably referred to herein as a “flexible film”, a “flexible film liner”, a “flexible film distribution liner”, a “flexible distribution liner”, a “flexible film dispenser liner” or a “flexible film distributor liner”; a “flexible film dispensing liner system”, a “flexible film distribution liner system”; or simply a “liner”. Hereinafter, the flexible film fluid-dispensing liner member of the present invention will be referred to as a “flexible film fluid-dispensing liner”and abbreviated as “FFDL”.

The FFDL can be a layered article of two or more layers. For example, in one embodiment, the FFDL includes at least two layers or faces of at least two different flexible film materials which have been bonded together by various means including, for example, (1) a heat sealing process; (2) an adhesive, (3) a tie layer, or (4) a combination of any two or more of the above bonding methods. The bonding process forms a fluid flow path in the form of a series or pattern of ducts (or passageways) embedded in the FFDL. The ducts of the FFDL has at least one inlet and a plurality of outlets to allow a fluid to flow through the FFDL entering from the inlet and exiting through the outlets. For example, using any one of the above bonding processes, the ducts of the FFDL can be defined by areas in the FFDL that are not bonded together to form the ducts; for example, areas in the FFDL that are not heat sealed, areas in the FFDL that lack adhesive/glue; or areas in the FFDL that lack a bonding tie layer. The above techniques for forming a fluid flow path (ducts or passageways) through the FFDL leads to the inflating of the ducts of the FFDL when the fluid passes therethrough.

In a preferred embodiment, the FFDL of the present invention is a multilayer FFDL that includes, for example: (a) at least one first flexible film substrate layer; and (b) at least one second flexible film substrate layer; wherein the first flexible film substrate layer is bonded to the second flexible film substrate layer forming the multilayer FFDL; wherein the multilayer FFDL has a flexibility property of from 3.6E-10 Nm to 2 Nm; and (c) at least one duct having at least one inlet and a plurality of outlets (e.g., at least two outlets), the at least one duct being disposed between the first and second layers for forming a path for a fluid to pass from the at least one inlet of the duct to the plurality of outlets of the duct.

Some of the advantages of the FFDL of the present invention include, for example: (1) the FFDL is made of a material with a low affinity to polyurethane and/or polyisocyanurate which is a material that could not be previously used with known injection molding technology, (2) using a low affinity to polyurethane material advantageously to increases the dispenser lifetime; (3) by using the FFDL, a dispenser geometry can be made that could not be previously produced via injection molding; and (4) fouling of the FFDL is reduced by ducts deformation induced by increased local pressure.

### BRIEF DESCRIPTION OF THE DRAWINGS

FIG. 1 is front view showing a FFDL of the present invention and a series of ducts in the FFDL for flowing a liquid fluid through the ducts of the FFDL. The ducts are shown in FIG. 1 with a predetermined geometry before flowing a liquid fluid through the ducts.

FIG. 2 is a cross-sectional view of the FFDL of FIG. 1 taken along line 2-2.

FIG. 3 is a cross-sectional view of a portion of the FFDL of FIG. 1 showing the dimensions of a single duct of the FFDL of FIG. 1 wherein the duct is deflated before fluid passes through the duct.

FIG. 4 is a cross-sectional view of a portion of the FFDL of FIG. 1 taken along line 4-4.

FIG. 5 is a cross-sectional view of a portion of the FFDL of FIG. 1 taken along line 5-5.

FIG. 6 is a cross-sectional view of a portion of the FFDL of FIG. 1 taken along line 6-6.

FIG. 7 is a cross-sectional view of the FFDL of FIG. 1 showing the ducts of the FFDL of FIG. 2 being inflated with flowing liquid fluid inside the ducts during usage of the FFDL.

FIG. 8 is a a portion of the FFDL cross-sectional view of FIG. 7 showing the dimensions of a single duct of the FFDL of FIG. 2 wherein the duct is inflated as fluid passes through the duct.

FIG. 9 is a cross-sectional view showing another embodiment of a FFDL of the present invention.

FIG. 10 is a cross-sectional view showing still another embodiment of a FFDL of the present invention.

FIG. 11 is a perspective front view of a dispensing device showing a FFDL fastened to a frame member for holding the FFDL in place.

FIG. 12 is a perspective exploded view of the dispensing device of FIG. 11.

FIG. 13 is an enlarged cross-sectional view of a portion of the dispensing device of

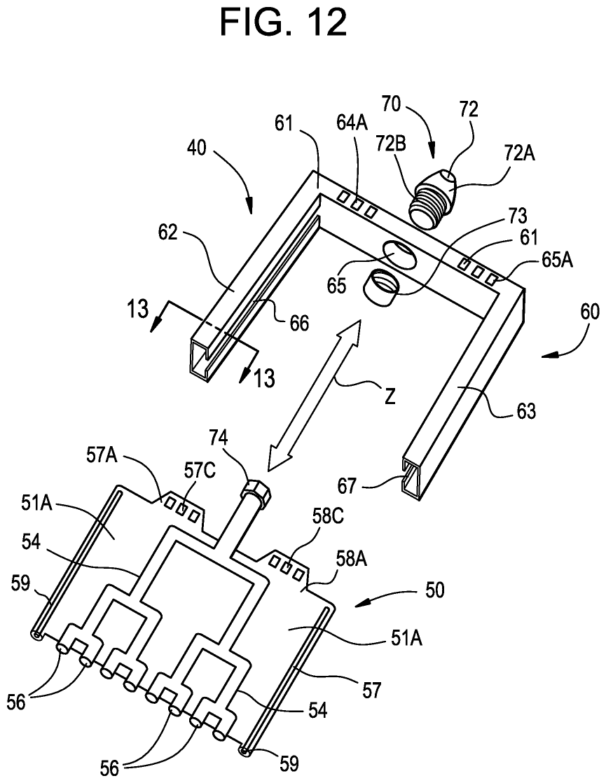

FIG. 12 taken along line 13-13.

FIG. 14 is a front view of a dispensing device showing a FFDL of the present invention fastened to a frame member for holding the FFDL in place before, during, and after the flow of liquid fluid through the ducts of the FFDL.

FIG. 15 is a top view of the dispensing device of FIG. 14.

FIG. 16 is a cross-sectional view of a portion of the dispensing device of FIG. 14 taken along line 16-16.

FIG. 17 is a partial cross-sectional view of a portion of the dispensing device of FIG. 16 taken along line 17-17.

FIG. 18 is a cross-sectional view of a portion of the dispensing device of FIG. 14 taken along line 18-18.

FIG. 19 is a cross-sectional view of a portion of the dispensing device of FIG. 14 taken along line 19-19.

FIG. 20 is an enlarged cross-sectional view of a portion of the dispensing device of FIG. 19 showing a connection assembly of the dispensing device of FIG. 19.

FIG. 21 is a schematic side view of a continuous process flow and production line (e.g., a rigid faced double belt lamination (RFDBL) process) showing several pieces of equipment for manufacturing a multilayer rigid foam sandwich panel member or article.

FIG. 22 is a perspective view of a rigid foam sandwich panel member prepared using the process and equipment of FIG. 21.

FIG. 23 is a cross-sectional view of the rigid foam sandwich panel member of FIG. 22 taken along line 23-23.

### DETAILED DESCRIPTION

As used throughout this specification, the abbreviations given below have the following meanings, unless the context clearly indicates otherwise: “=” means “equals”; “>” means “greater than”; “<” means “less than”; μm=micron(s), nm=nanometer(s), g=gram(s); mg=milligram(s); L=liter(s); mL=milliliter(s); ppm=parts per million; m=meter(s); mm=millimeter(s); °=degrees; cm=centimeter(s); min=minute(s); m/min=meters(s) per minute; s=second(s); Nm=Newtons-meters; hr=hour(s); ° C.=degree(s) Celsius; ms=milliseconds; %=percent, vol %=volume percent; and wt %=weight percent.

In one broad embodiment, the present invention includes a FFDL useful for manufacturing a flexible film fluid-dispensing device (also referred to as a flexible film fluid dispenser). The fluid that contacts the FFDL of the fluid dispenser can be any fluid such as any foamable (or foam-forming) liquid reactive mixture including PUR or PIR formulations. For example, one preferred embodiment of the present invention provides FFDL for a fluid dispenser that will receive a foam-forming reactive mixture or emulsion; and in particular, the fluid is a reactive mixture of components that react to form a polyurethane or polyisocyanurate foam such as a mixture of an isocyanate reactant and a compound that reacts with the isocyanate reactant including polyol reactants and other additives or reagents commonly used to prepare a PUR or PIR foam product.

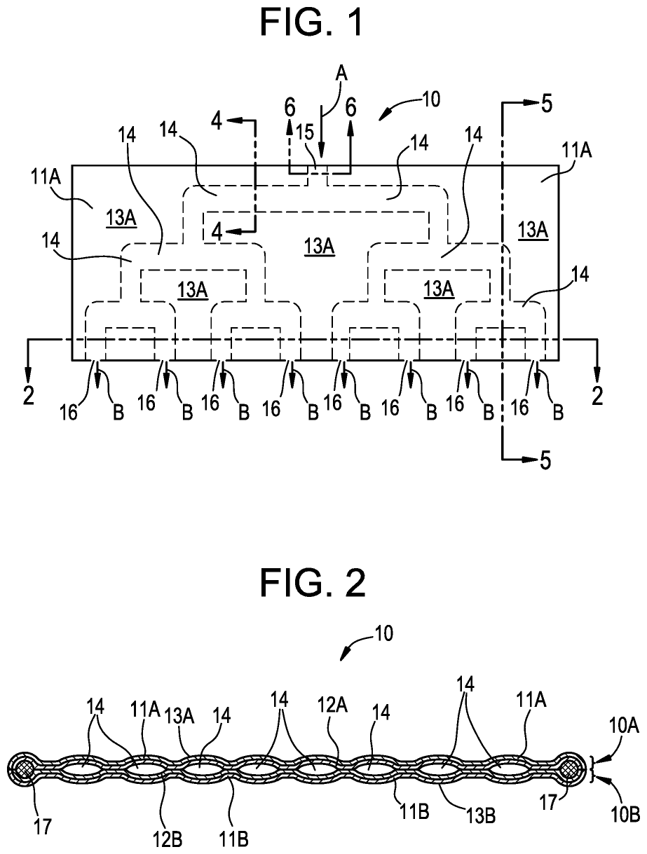

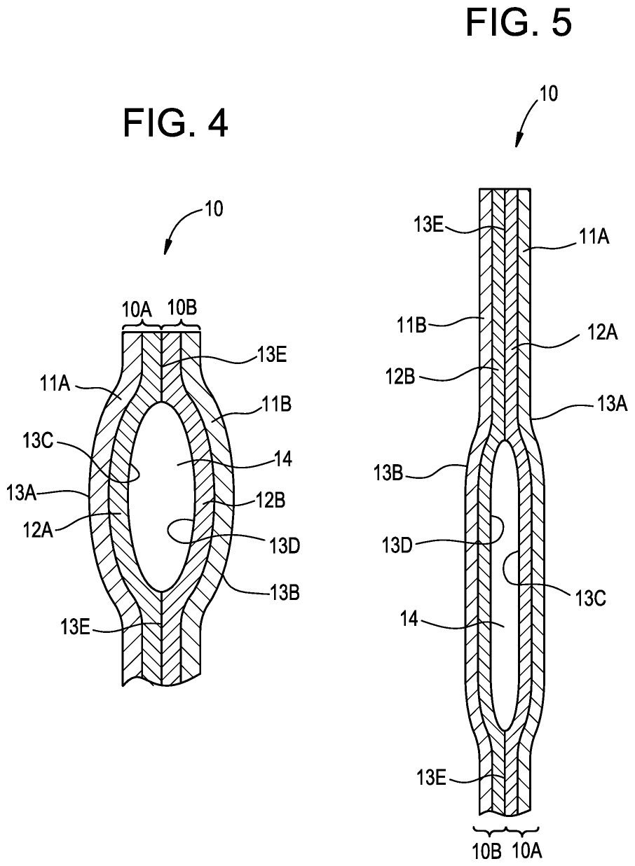

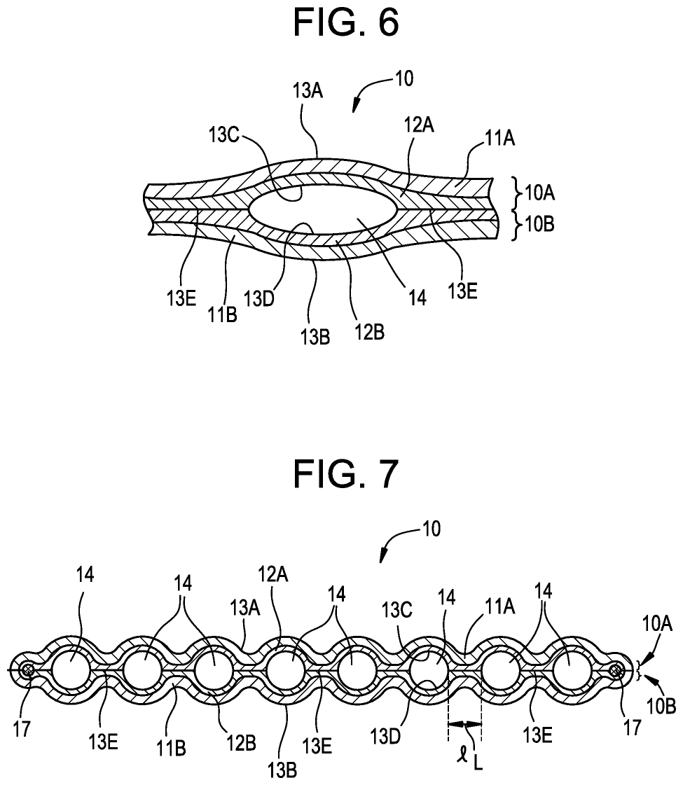

With reference to FIGS. 1-8, there is shown a multilayer FFDL of the present invention, generally indicated by reference numeral 10. The multilayer FFDL 10 includes, for example: a first flexible multilayer film substrate generally indicated by reference numeral 10A bonded to a second flexible multilayer film substrate generally indicated by reference numeral 10B. The film substrates 10A and 10B are bonded to each other via each of the substrates bondable inside layers 12A and 12B, respectively, leaving each the surfaces 13A and 13B of the outside facing layers 11A and 11B, respectively, facing externally to the atmosphere. The FFDL 10 includes at least one duct (passageway or flow path) 14 having at least one inlet 15 and at least two or more outlet(s) 16, the at least one duct 14 being disposed between the first and second substrates 10A and 10B for forming a path for a fluid to pass from the at least one inlet 15 of the duct 14 to the at least two or more outlet(s) 16 of the duct 14. The FFDL receives a fluid feed at the inlet 15 as indicated by directional arrow A in FIG. 1; and the fluid exits the FFDL through the two or more outlets 16 as indicated by directional arrow B in FIG. 1.

With reference to FIGS. 2-8, there is shown the first substrate 10A which includes, for example, at least a first flexible film outer layer 11A; and at least a second flexible film inner layer 12A; wherein the first flexible film outer layer 11A is bonded to the second flexible film inner layer 12A forming the first flexible multilayer film substrate 10A. The flexible multilayer film member 10 also includes a second flexible multilayer film substrate 10B including at least a first flexible film outer layer 11B; and at least a second flexible film inner layer 12B; wherein the first flexible film outer layer 11B is bonded to the second flexible film inner layer 12B forming the second flexible multilayer film substrate 10B.

The structure of each of the film substrates 10A and 10B of the FFDL of the present invention can encompass one layer or multiple layers. The material of the layers useful for manufacturing the film substrates 10A and 10B include, for example: polyethylene (i.e., PE), linear low density polyethylene (LLDPE), polyethylene terephthalate (i.e. PET), oriented polyethylene terephthalate (i.e. OPET), metalized polyethylene terephthalate (i.e. mPET), polypropylene (i.e. PP), oriented polypropylene (i.e. OPP), biaxially oriented polypropylene (i.e. BOPP), oriented polyamide (i.e., OPA)/Nylon, silicones and mixtures thereof; and/or a coextruded film structure (i.e., COEX) encompassing any or all the aforementioned film layers. In a preferred embodiment, each of the film substrates 10A and 10B can be made up of, for example, two layers such as a two-layer film structure comprising, for example, (a) a first PET layer and (b) a second PE layer.

The present invention makes it possible: (1) to use material with low affinity to polyurethane, which is a material that could not be previously used with known injection molding technology; (2) to use a material with a low affinity to polyurethane material to advantageously increase the lifetime of the FFDL; (3) to use a fluid dispensing device including the FFDL and a dispenser geometry that could not be previously produced via injection molding; and (4) to reduce fouling of the FFDL by the deformation of the ducts in response to increased local pressure.

The unique construction of the FFDL allows using both laminated and coextruded films. Therefore, each layer of a multilayer FFDL can be tailored for a specific need such as a specific stiffness and/or a specific (generally lower) chemical affinity with polyurethane. The FFDL, which includes one layer or multiple layers, can have an overall thickness appropriate for the enduse of the FFDL. For example, each layer of the FFDL can have a thickness in the range of from 20 μm to 2 mm in one general embodiment; from 50 μm to 1 mm in another embodiment; and from 60 μm to 500 μm in still another embodiment.

As aforementioned, in FIGS. 1-8 there is shown one embodiment of a multilayer FFDL 10 of the present invention having two substrates 10A and 10B with each substrate having a two-layer structure, for example, film substrate 10A includes an external layer 11A and an internal layer 12A; and the film substrate 10B includes an external layer 11B and an internal layer 12B. The external layers 11A and 11B provide structural stiffness and integrity to the FFDL 10 while the internal layers 12A and 12B, which are in contact with the flow of a fluid, exhibit a low chemical affinity with the fluid when the fluid contacts the internal layers. The fluid can include for example a polyurethane-based reactive mixture fluid. The advantages of having an inner layer having a low chemical affinity with a fluid such as polyurethane-based reactive mixture include, for example (1) fouling of the fluid flowing through the ducts of the FFDL is reduced; and (2) the working life of the FFDL is prolonged.

The dimensions of the FFDL may vary depending on the application in which the FFDL will be used. For example, the FFDL's width w includes, for example, a width from 200 mm to 2,000 mm in one embodiment, from 800 mm to 1,350 mm in another embodiment; and from 900 mm to 1,150 mm in still another embodiment when using the FFDL for fabricating a fluid dispensing device that is used, for example, in a continuous process for manufacturing a panel member such as a RFDBL process (see FIG. 21). Generally, the width of the FFDL needs to have dimensions sufficient to cover the width of a panel manufactured by the RFDBL process. In other embodiments, more than one FFDL having a specific width can be used in a RFDBL process to provide adequate coverage the width of the panel.

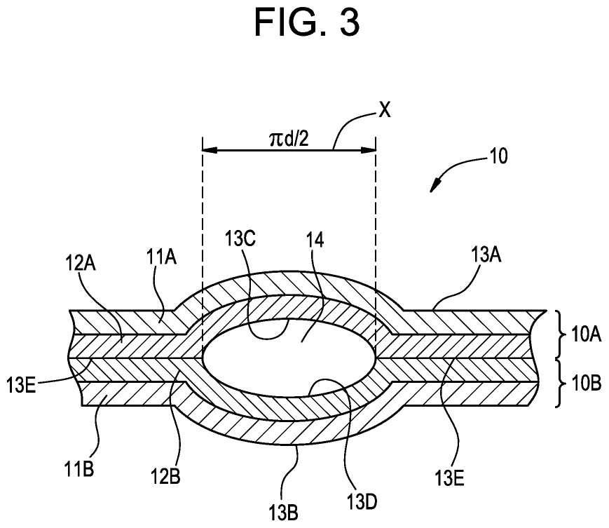

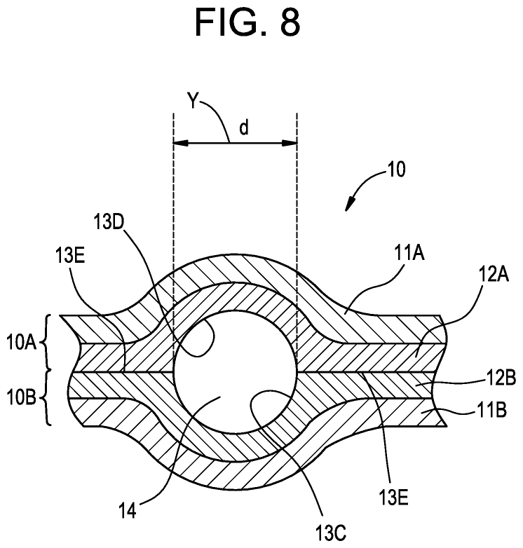

In FIG. 3, there is shown a single duct 14 representive of each of the plurality of ducts 14 of the FFDL. The ducts 14 are created by bonding (e.g., by a heat sealing process) portions of the substrate 10A to portions of the substrate 10B via the inner layers 12A and 12B at predetermined spaced apart portions of the FFDL 10. As a result, of the bonding process, the ducts 14 are formed having unbonded surface portions 13C and 13D of the inner layers 12A and 12B, respectively; and having bonded portions at a bonding line 13E. The ducts 14 are formed embedded inbetween substrates 10A and 10B. When the FFDL 10 is not in use, the ducts 14 are in a deflated position, that is, in a relatively flat (or oval in shape) position, as shown in FIGS. 3-6; and the ducts 14 have a certain characteristic dimension (as indicated by arrow X in FIG. 3). When the FFDL 10 is in use and fluid is flowing through the ducts 14, the flow ducts 14 inflate automatically (shown in FIGS. 7 and 8) and allow the fluid to go through the ducts 14 formed by the non-sealed areas 13C and 13D of ducts 14 of the FFDL 10. The diameter, d, of the flow ducts 14 (as shown by arrow Y in FIG. 8) is the diameter of the ducts 14 when the ducts are inflated by the flow of fluid through the ducts. Ultimately, the fluid flowing through ducts 14 exits the FFDL through outlets 16 of the ducts 14 as indicated by directional arrow B in FIG. 1.

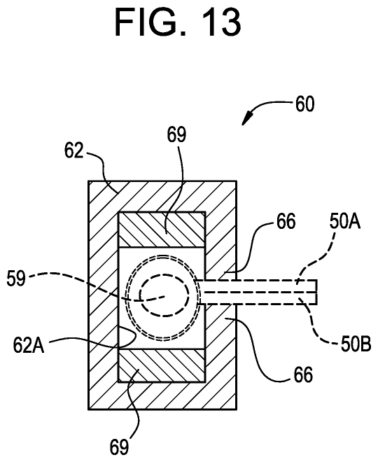

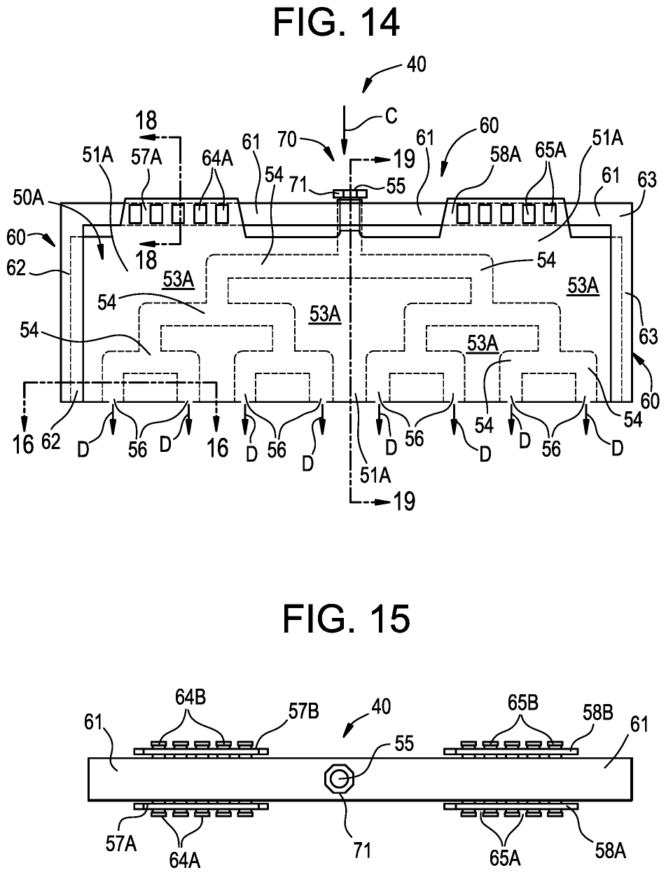

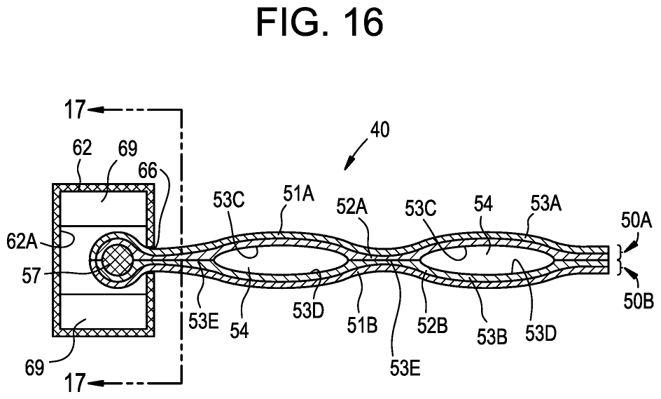

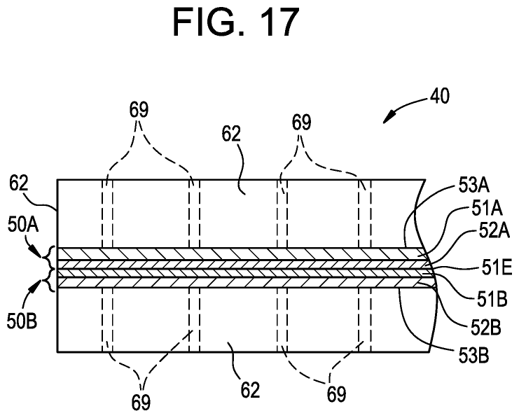

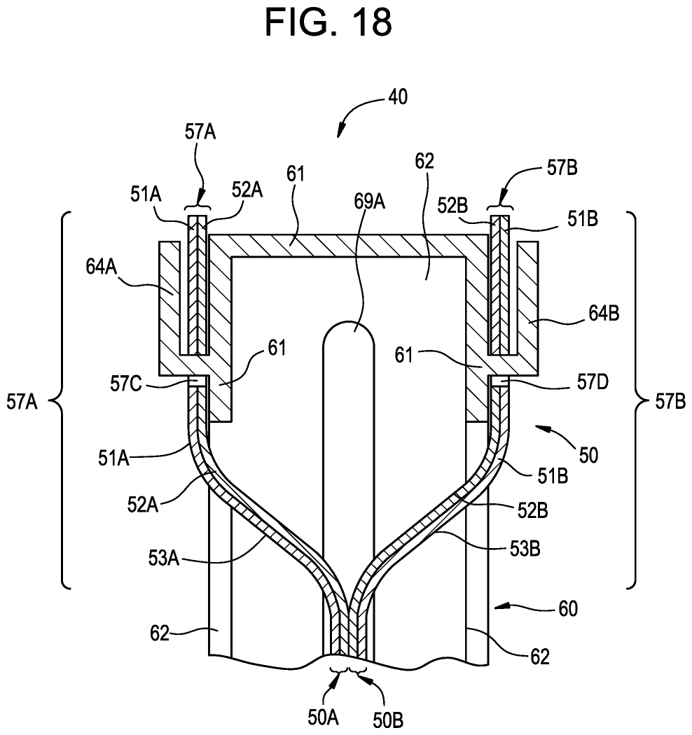

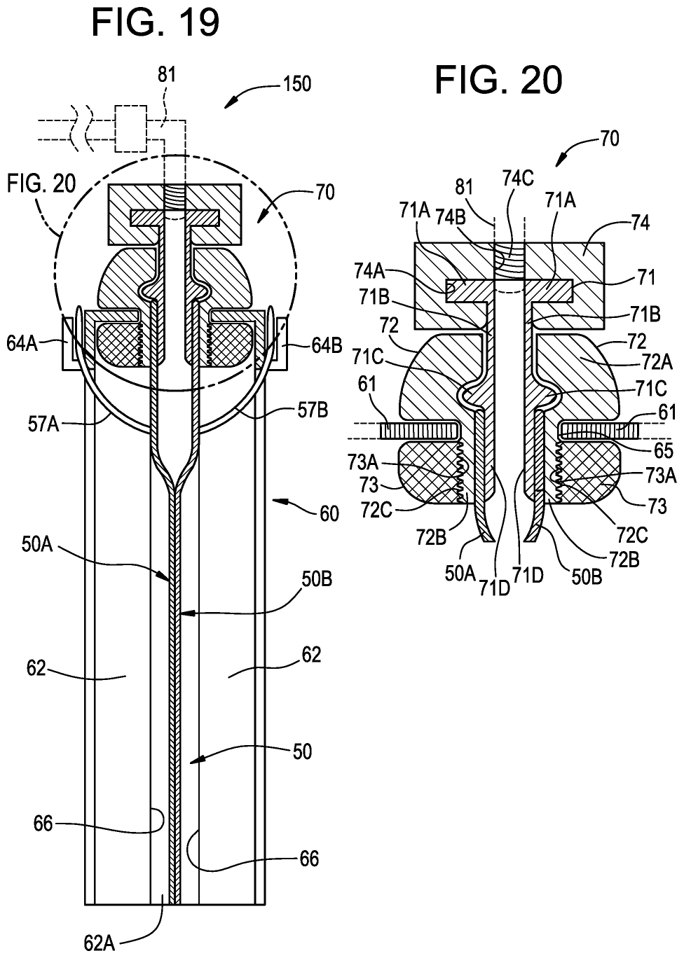

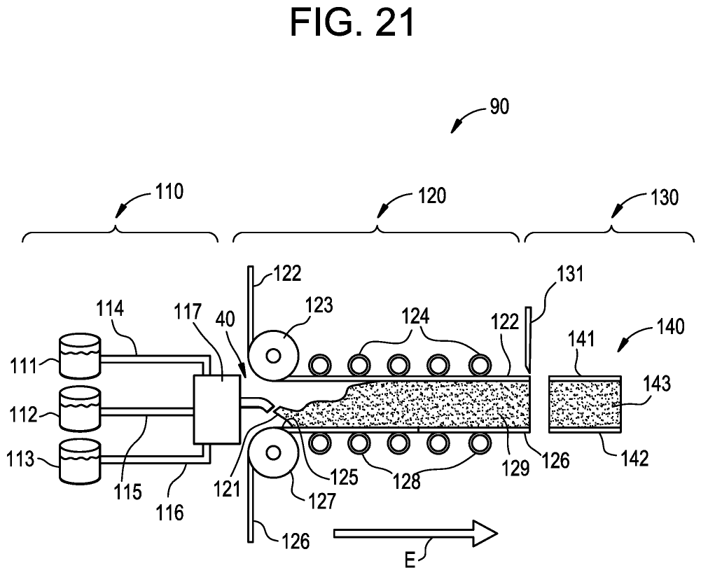

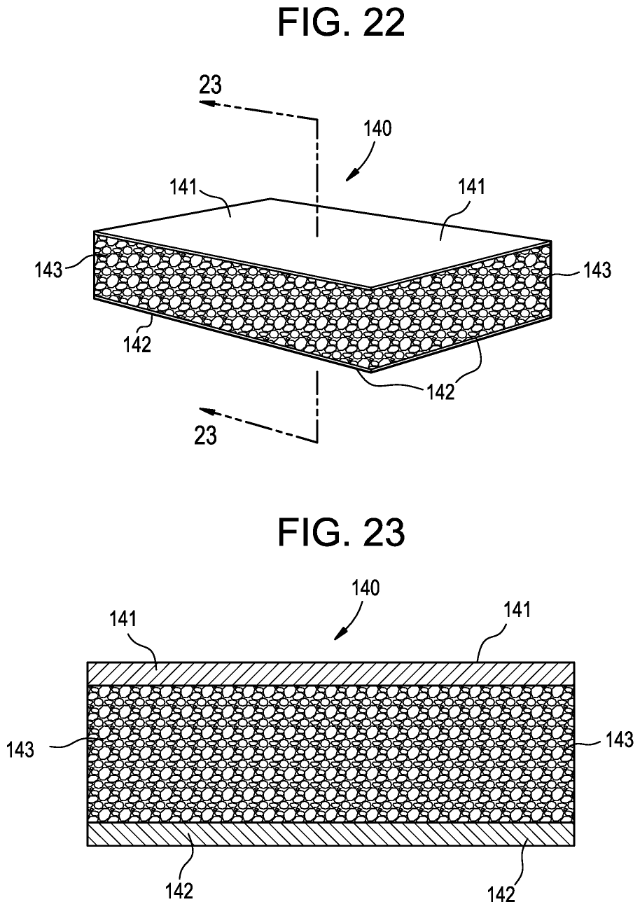

In one embodiment, the FFDL can be used in a fluid dispensing device such as the dispenser 40 shown in FIGS. 11-20; and, in turn, the dispenser 40 can be used in a production line 90 shown in FIG. 21 for producing a foam panel member 140 shown in FIGS. 22 and 23. In a preferred embodiment, a reactive fluid 121 (e.g., a foam-forming reactive mixture) can be dispensed via a dispenser 40 wherein the fluid exits outlet 56 of the dispenser 40 and deposits onto a lower moving metal lamination sheet, for example, sheet 126 shown in FIG. 21. The moving sheet 126 receives the foam-forming fluid 121 on the surface 125 thereof; and the foam-forming fluid 121 is allowed to expand until the foam contacts the upper moving metal lamination sheet 122.

In constructing a dispensing system using the FFDL 10 of the present invention, the flow path of the ducts 14 can be constructed and designed as appropriate for a desired application. For example, the flow path for the fluid in the FFDL is defined by the negative of the impression of a heat-sealing mold. This FFDL production technique allows to easily and inexpensively define complex and efficient flow paths otherwise impossible with standard construction methods and apparatuses such as rigid injection-molded dispensers or multi-branching pipe dispensers. The production process for the FFDL, also, allows to easily change the flow path geometry to adapt to different emulsion viscosities and/or to different flow rates. Although the ducts 14 has one inlet 15 as shown in FIG. 1, the flow path of fluid flowing through ducts 14 can also be modified to have more than one inlet or multiple inlets (not shown) according to the requirements of a particular production line.

The flexible nature of the FFDL 10 and the system of flow ducts 14 prolong the working life of a dispenser incorporating the FFDL 10 by reducing fouling. In fact, when a duct obstruction occurs, the increased local pressure will deform the flexible walls of the FFDL ensuring the flow of the polyurethane or polyisocyanurate mixture. This phenomenon in conjunction with the low polyurethane-surface chemical affinity may also lead to the expulsion of the formed obstruction. The aforementioned phenomenon results in a relevant prolongation of the fluid dispenser's working life.

With reference to FIGS. 1-8 again, one process of fabricating the FFDL 10 containing ducts 14 includes, for example, a heat-sealing process. The series or pattern of ducts 14 create a flow path for the fluid to be dispensed. The flow path is defined by the negative impression of a sealing die which heat seals some portions of the FFDL (see heat sealed line 13E) and leaves other portions of the FFDL not heat sealed forming ducts 14 (i.e., creating ducts 14 by the non-heat sealed areas 13C and 13D). In one embodiment, the FFDL includes, for example, at least two areas, (i) a solid area wherein a fluid cannot flow therethrough (e.g., the integrally bonded surface portions of substrates 10A and 10B at the bond line 13E (as shown in FIGS. 3 and 8); and (ii) an area defining a flow path for fluid to pass through the FFDL (e.g., the unbonded substrates 10A and 10B producing the ducts 14 with the layers 12A and 12B having unbonded surface portions 13C and 13D, respectively (as shown in FIGS. 3 and 8). For example, the flow path of the fluid can be in the form of a pattern or a series of inflatable ducts 14 for fluid such as an emulsion to flow therethrough.

In a preferred embodiment, the substrates 10A and 10B useful for producing the FFDL 10 described above are made of heat sealable material to provide heat-sealed areas and flexible areas for forming the pathways or ducts 14 for the FFDL 10 used to dispense a fluid flowing through the ducts 14.

In one embodiment, for example, the sealing process (temperature and pressure) need to be such that the process conditions provide the seal integrity and seal strength which allows the FFDL to withstands the pressure induced by the fluid flow. Moreover, the sealing process (e.g. pressure and temperature) needs to be such that the structural performance of the material layers close to the sealing area do not deteriorate.

In one preferred embodiment, the ducts or channels 14 can be heat welded by pressing polymeric sheets (i.e., substrates 10A and 10B) together such that the inner layers of the substrates (e.g., inner layers 12A and 12B) contact each other; and applying heating to the pressed layers for enough time to cause a weld of the two inner layers to specific areas of the pressed layer. And in so-doing, the desired ducts or channels 14 are formed for the fluid to flow in. The layers may generally be laminates of, for example, LLDPE, as the inside or inner layers 12A and 12B with another film as the outside or outer layer 11A and 11B, such as PET. The FFDL construction above would have some stiffness; however, in another embodiment, using only an LLDPE film for the substrates 10A and 10B can provide more flexibility to the FFDL if desired.

Forming the FFDL with the above materials can be carried by known techniques in the art, for example, conventional processes for making “PacXpert™” bags as described in U.S. Pat. Nos. 7,147,597B2; 8,231,029; and 8,348,509; and U.S. Patent Application Publication Nos. 2017/0247156; 2015/0314928; and 2015/0314919. In this process, two layers of a laminate are brought together and bonded using a specially designed rig, or machine in the manner described in the above patent references.

The process of making a FFDL using a laminate of, for example, 150 μm, include the following conditions: a sealing pressure of from 3 bar to 5 bar; a temperature range of heating shoe between 140° C. and 170° C. for the laminate. In another embodiment, for a monolayer of LLDPE (5056, 5400 or Elite) the temperature is about 130° C.; and a time of application is in the range of 500 ms to 1,000 ms (1 sec).

Some embodiments of the LLDPE layer include, for example, DOWLEX LLDPE 5056, DOWLEX LLDPE 5400 or DOW ELITE (all of which are available from The Dow Chemical Company). Such LLDPE used as the inside layer has a natural dis-affinity for PU (the PET layer used as the outside layer has an affinity for the PU). This desirable property is advantageous because the dis-affinity for PU property of the inside LLDPE layer reduces fouling which is a stated advantage of the design. The same LLDPE layer(s) are easy to heat bond through the application of heat and pressure as described above.

Different film structures can be conceived for the FFDL, encompassing only PE layers, PE and PET layers, PE, PET and OPA layers. In general, a sealing bar temperature comprised between 100° C. and 200° C., a sealing bar pressure comprised between 0.1 bar and 9 bar and a residence time between 0.15 s and 2 s characterizes the FFDL production process.

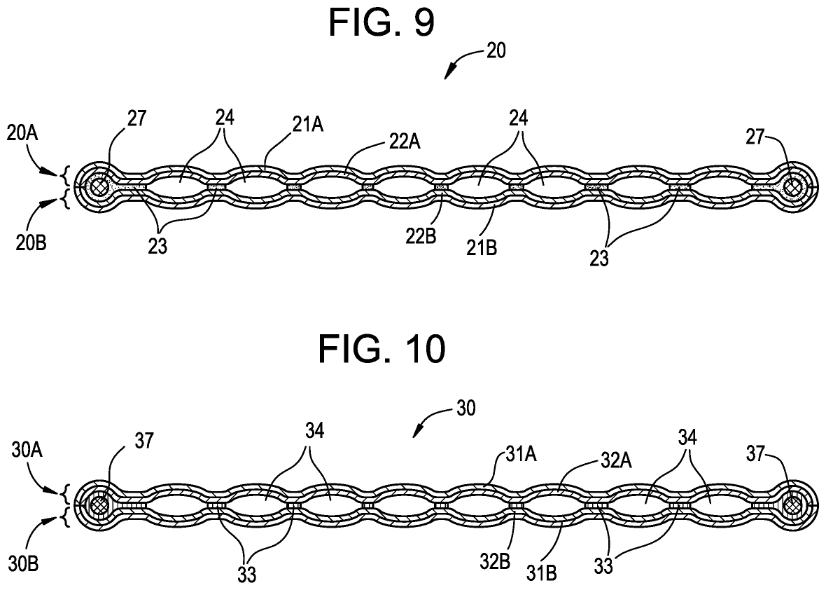

The FFDL 10 can be made using alternative embodiments, for example, in one embodiment and with reference to FIG. 9, there is shown a FFDL, generally indicated by reference numeral 20, including an adhesive layer 23 disposed inbetween the film inner layers 22A and 22B of the substrates 20A and 20B, respectively, of the FFDL 20. The adhesive layer 23 can be used to provide the bonding areas and flexible areas for forming the pathways/ducts 24 having inlets (not shown, but similar, e.g., to inlet 15 of FIG. 1) and outlets (not shown, but similar, e.g., to outlets 16 of FIG. 1) of the FFDL 20.

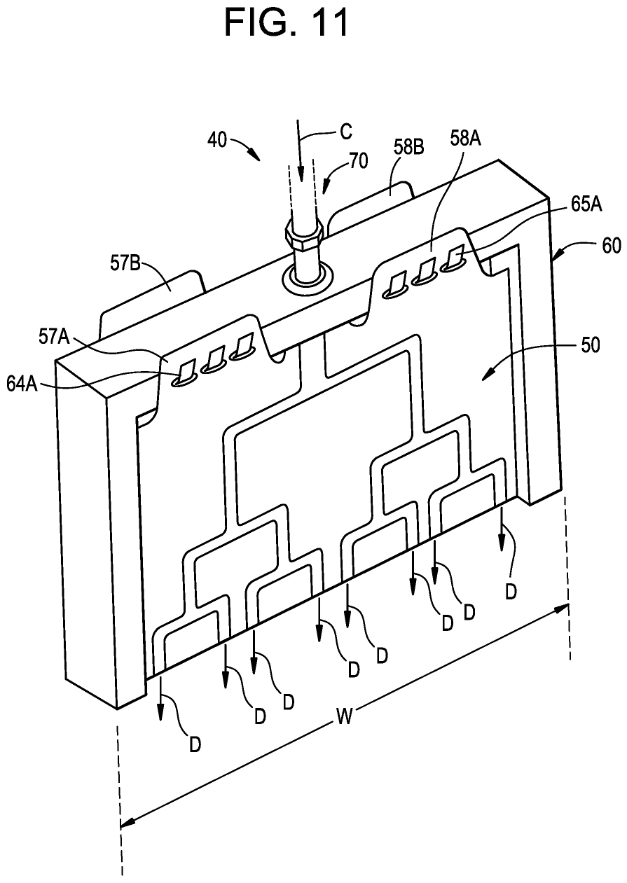

In another embodiment, and with reference to FIG. 10, there is shown a FFDL, generally indicated by reference numeral 30, including a tie layer 33 disposed inbetween the film substrates or layers 30A and 30B of the FFDL 30. The tie layer 33 can be used to provide the bonding areas and flexible areas for forming the pathways/ducts 34 having inlets (not shown, but similar, e.g., to inlet 15 of FIG. 1) and outlets (not shown, but similar, e.g., to outlets 16 of FIG. 1) of the FFDL 30.

And, in still another embodiment, a FFDL including a combination of an adhesive layer and a tie layer (not shown) can be used to provide the bonding areas and flexible areas for forming the pathways/ducts similar to the ducts 14 of the FFDL 10 shown in FIG. 1.

In general, the FFDL of the present invention has several advantageous properties including, for example, the FFDL: (1) is made of a flexible multilayer film structure; (2) is constructed of a durable (or strong) material; (3) has a low affinity for a polyurethane composition fluid; (4) is made of heat sealable material; (5) has dimensions such as to cover a panel width; (6) has a flow path that comprises the clearance between the distribution pipe of the dispenser and the moving metal sheet on which a fluid from the dispenser pipe has flowed thereon; (7) has a film structure that can encompass one layer or multiple layers; and (8) has a film structure that can be laminated or coextruded.

For example, the flexibility D of the FFDL is from 3.5e-10 Nm to 4 Nm in one embodiment, from 4.5e-9 to 2 Nm in another embodiment, and from 5e-5 Nm to 1 Nm in still another embodiment. The flexibility property of the FFDL is measured, for example, by the following equation:

$$D = \frac{{Et}^{3}}{12 ( 1 - {v}^{2} )} \qquad Equation ( I )$$

where t is the thickness, E is the Young modulus and v is the Poisson ratio.

For example, the multilayer FFDL is made of film layers that have a strength to be functional in contacting fluid and pressures of processing fluid as measured by ASTM D1708-13 method. The strength, i.e., strain at break ε_{break}, of the FFDL is from 0.11 to 4 in one embodiment, from 0.18 to 8 in another embodiment, and from 0.1 to 10 in still another embodiment.

For example, the FFDL can be made of heat sealable material; and the FFDL can be heat sealed at temperatures of from 140° C. to 160° C. in one embodiment, from 100° C. to 150° C. in another embodiment, and from 110° C. to 170° C. in still another embodiment.

For example, the dimensions of the FFDL are such that the distribution of fluid covers the whole width of a panel article, or multiple FFDLs are used in order to cover the whole width of the panel. Typically, a panel width can be from 0.1 m to 2 m in one embodiment, from 0.4 m to 1.8 m in another embodiment, and from 0.9 m to 1.46 m in still another embodiment.

For example, the FFDL has a flow path that comprises the clearance between the distribution pipe of the dispenser and the moving metal sheet on which a fluid from the dispenser pipe has flowed thereon. Generally, the clearance is from 50 mm to 300 mm in one embodiment, from 15 mm to 400 mm in another embodiment, and from 100 mm to 200 mm in still another embodiment.

For example, the FFDL has a film structure that can encompass one layer or multiple layers. Generally, the number of layers of the FFDL is from 1 to 16 in one embodiment, from 1 to 14 in another embodiment, from 1 to 4 in still another embodiment, and from 1 to 3 in yet another embodiment.

For example, the FFDL has a film structure that can be manufacturing with many different types of processes; thus providing the process operator different options suitable for a particular process equipment and process conditions. For example, the layers comprising the FFDL can be laminated, coextruded or the combination of the aforementioned processes.

One of the objectives of the present invention is to provide a novel FFDL and a dispenser design incorporating the FFDL such that the design of the dispenser is technically superior in function to known prior art dispensers. The superior industrial design of the dispenser of the present invention is capable of readily dispensing an emulsion for PIR/PUR panel producers using an RFDBL continuous process.

With reference to FIGS. 11-20, there is shown one embodiment of a fluid dispensing device (or dispenser), generally indicated by reference numeral 40. In one general embodiment, the fluid dispenser 40 includes: (a) the FFDL described above, generally indicated by reference numeral 50; (b) a rigid frame, generally indicated by reference numeral 60, for holding the FFDL in place; and (c) a connection means, generally indicated by reference numeral 70, for connecting the FFDL and dispensing device 40 to the outlet pipe of a fluid production line. The connection means or connector 70, which in a preferred embodiment is a hermetically sealed junction/s, is used for connecting the FFDL to the outlet means of a fluid manufacturing production line. The FFDL and the rigid frame are connected to a production system (not shown) by means of the hermetic connector, component 70, for feeding a fluid, from the production system, into the dispenser 40. The production system can include, for example, a DBL production process used for producing PUR and PIR foam panels. And, in preferred embodiments, the DBL process for fabricating panels can include an RF-DBL and an FF-DBL. The FFDL 50 used to form the fluid dispenser 40 is as described above with reference to FFDL 10.

Various rigid materials such as plastic, metal, composites, wood, and the like, and combinations thereof, can be used to produce the frame 60; and various designs for the rigid frame member 60 which holds in place the FFDL 50 are possible. In a preferred embodiment, the FFDL 50 is removable attached to the frame member 60. For example, as shown in FIGS. 11-20, the FFDL is kept in place by hanging the FFDL in place using holding hook members 64A and 65A on the top part 61 of the frame 60 on one side of the frame; and holding hook members 64B and 65B on the other side of the top part 61 of the frame 60. The FFDL 50 is held in the frame 60 by a “hanging” action using window cutouts or openings 57C and 58C in flap portions 57A and 58A, respectively, on one side of the FFDL 50; and using window cutouts or openings 57D and 58D in flap portions 57B and 58B, respectively, on one side of the FFDL 50 (see FIGS. 14, 15, and 18). The flaps 57A, 57B, 58A and 58B are another portion of substrates 50A and 50B which have not been sealed; and which are separate from, but each portion integral with, the substrates 50A and 50B respectively of the main body of the FFDL 50. The FFDL 50 can be removed from the frame member 60 by detaching the openings 57C, 57D, 58C and 58D of the FFDL 50 from the hooks 64A, 64B, 65A and 65B, respectively. The FFDL is replaceable with a new FFDL 50 once the working life of the FFDL 50 has ended or the ducts 54 become obstructed for any reason. In addition to the hooks/openings incorporated into the top part of the dispenser described above to hold the top part of the FFDL in place, guide rods can also be incorporated into the side edges of the FFDL to hold the sides of the FFDL in place in the dispenser frame.

For example, in FIGS. 12, 13 and 16, there is shown two elongated guide rods 59 parallel to each other in the horizontal plane of the FFDL 50; and the guide rods 59 are embedded in the FFDL 50 at each longitudal edge of the horizontal plane of the FFDL 50. In a preferred embodiment, the guide rods 59 are inserted inbetween the substrates 50A and 50B of the FFDL 50 before the heat-sealing process which forms the bond line of the substrates 50A and 50B. The guide rods 59 are used to insert the edges of the FFDL 50 into the U-shaped channel sections 62 and 63 of the frame 60 via slits 66 and 67 in the sections 62 and 63, respectively. In this embodiment, the FFDL 50 slides, guided by the rods 59, via the slits 66 and 67 of the sections 62 and 63 of the frame 60 up to the top section 61 of the frame member 60 where the liner 50 is hung on hooks 64A and 65A via openings 57C and 58C of flaps 57A and 58A, respectively, of the FFDL 50 on one side of the frame top section 61; and on hooks 64B and 65B via openings 57D and 58D of flaps 57B and 58B, respectively, of the FFDL 50 on the other side of the frame top section 61 of the frame member 60.

Although not shown, other embodiments of holding the FFDL in place can be readily constructed by those skilled in the art. For example, two films can be inserted within a rigid frame before the heat sealing process and then the two films and the frame can all be heat sealed together thereby the two layers of film being held in place in the frame. In another embodiment, the rigid frame can be made of two detachable halves. The FFDL is inserted between the two frame halves and then the two frame halves are reattached (e.g., clipping, binding, snapping and the like) together gripping the FFDL inbetween the two halves. In still another embodiment, the rigid frame can include side clip members incorporated all around the internal periphery of the frame that hold the FFDL in place. In yet another embodiment, the rigid frame can include two side doors/panels that are open during the insertion of the FFDL and closed during production. The doors can be transparent to allow the viewing of the flow of formulation in the ducts. The two doors may have a layer of flexible foam on the surface in contact with the FFDL in order to keep the FFDL in place.

The frame width w (as shown by dimensional arrow W in FIG. 11) of frame 60 needs to be such that during usage the flow ducts 54 are able to inflate but also the FFDL is tensioned and held in place. Therefore, the width w of the rigid frame needs to satisfy the following Equation (II):

$$w = \frac{N π d}{2} + ( N + 1 ) l \qquad Equation ( II )$$

where N is the number of the outlet ducts of the FFDL, d (as shown by arrow Y in FIG. 8) is the diameter of the flow ducts 14, and l (as shown by arrow L in FIG. 7) is the distance between the outlets of the flow ducts (see FIGS. 3, 7, and 8 showing the geometry of the FFDL and ducts before and during usage).

The connection means (preferably a hermetic connector) 70 between the FFDL and the RFDBL output pipe/pipes can be achieved with different solutions as will be apparent to those skilled in the art. For example, in one embodiment, shown in FIGS. 12, 19 and 20, a fitment member 71 comprising fitment flange section 71A, top tubular section 71B, annular ridge section 71C, and bottom tubular section 71D all integral with each other forming fitment 71. The bottom tubular section 71D is heat sealed to the substrates 50A and 50B of the FFDL 50 using a heat-sealing process. The fitment 71 can be held in place to the top section 61 of the frame 60 using a securing assembly including for example a top flange member 72 having a top flange section 72A integral with a bottom tubular section 72B; the top flange section 72A being disposed above the surface of the top section 61 of the frame 60 and the tubular section 72B being inserted through the orifice 65 of top section 61 of the frame 60. The tubular section 72B has male threads 72C . The securing assembly further includes a bottom annular ring member 73 being disposed below the surface of the top section 61 of the frame 60; and having female threads 73A for receiving the male treads 72C of section 72B which is treadably removable from the flange member 72. Once threaded securely, the top flange member 72 and bottom ring member 73 hold the FFDL 50 in place on the top section 61 of the frame member 60.

The hermetic connection 70 further includes a nut member 74 having an internal circular ring groove 74A for receiving the flange section 71A of the fitment 71; the nut 74 being rotatably mounted on the flange section 71A of the fitment 71. The nut member 74 also includes an orifice 74B with female threads 74C for receiving a fluid production pipe member 81 having male threads for removably attaching pipe member 81 to the female threads 74C of nut member 74. Then, the nut member 74 with the fitment 71 can be threadably connected (i.e., screwed) to the pipe member 81. The connector 70 is essentially made of at least two parts. A first part of the connector 70 includes the fitment 71 with securing assembly 72 and 73 to fix the FFDL 50 to the frame 60 and to create a funnel to feed a fluid to the FFDL 50. And, a second part of the connector 70 includes a nut 74 to connect the first part that has been previously screwed to the outlet pipe member 81 of a fluid feed and production line 150 (shown in FIG. 19).

In general, the process of fabricating the dispenser system i.e., the dispensing device 40, of the present invention includes the steps of: (A) providing a FFDL that is flexible and heat-sealable; (B) subjecting the FFDL to a heat-sealing process wherein the flow path for the fluid to be dispensed is defined by the negative impression of the sealing die; (C) providing a rigid frame for holding the FFDL in place; and (D) combining the FFDL and the rigid frame together to form the dispenser.

Some advantageous properties and/or benefits exhibited by the dispenser made by the above process of the present invention include, for example: (1) ease of production allowing the creation of complex flow path geometry otherwise impossible; (2) providing flexibility in covering different flow rate and formulations; (3) specialization of the different layer's material aiming at different performance, i.e. external layer for structural strength and integrity while interior layer with low chemical affinity with PU/PIR liquid mixture; and (4) as a consequence of the material layer specialization fouling can be reduced leading to a prolongation of the dispenser working life.

Currently, the dispenser lifetime in a typical process is about 4 hours (hr). This time period relates to the fact that the reacting flow mixture flowing through the distributor or dispenser will have zero velocities at the contact with the walls of the ducts of the FFDL of the dispenser. This means that a thin layer of fluid is stagnant at the walls of the ducts, and thus, the fluid has the time to react and to create a film of reacted material at the walls of the ducts. The reaction at the walls of the ducts reduces the internal diameter section area of the duct available for the fluid to pass through the duct, until the ducts clog completely. This phenomenon cannot be completely removed, but using materials with low affinity to PUR/PIR liquid mixtures can permit to maintain a thin film of reacted material at the walls of the ducts for a longer period of time, while the flexibility of the dispenser could permit to automatically release these reacted foam because of the higher pressure produced by the fluid, once the section area is reduced. This also permits to design the distributor geometry, without taking in account fouling problems, while currently for example velocities lower than 2.5 m/s are discouraged in order to reduce the risk of fouling (see patent US 2017/00285619 page 3 paragraph 0036), and this has a direct impact on the dispenser geometry.

In one general embodiment, the useful working life of a FFDL of the present invention and the dispenser lifetime including the FFDL is >4 hr in one embodiment; >8 hr in another embodiment; and >16 hr. In other embodiment, the FFDL of the present invention can last as much as up to 24 hr or more.

Once the dispensing device 40 has been assembled as described above, the dispenser 40 can be used in a process for producing a panel article 140 as shown in FIG. 21. With reference to FIG. 21, there is shown a schematic flow process for a continuous process of manufacturing a panel member as shown in FIGS. 22 and 23. In FIG. 21, there is shown a process generally indicated by reference numeral 90 including a dosing and mixing section generally indicated by reference numeral 110, a foam-forming section generally indicated by reference numeral 120 and a cutting and stacking section generally indicated by reference numeral 130.

With reference to FIG. 21 again, the continuous process 90 for manufacturing a panel member 140 can include, for example, a RFDBL process. The fluid flow path exiting the FFDL comprises the clearance between the distribution pipe of a dispenser 40 including the FFDL and the lower moving metal sheet 126 of the RFDBL process 90. The angle between the FFDL/dispenser 40 and the moving metal sheet 126 is between a vertical installation, i.e. α=90°, and a horizontal installation, i.e. α=0°. Therefore, the FFDL/dispenser height h is from 15 mm to 400 mm in one embodiment, from 50 mm to 300 mm in another embodiment; and from 100 to 200 in still another embodiment.

In one general embodiment, the process for manufacturing a panel article includes, for example, the steps of: (a) attaching the dispenser described above to a production line via the hermetic connector; (b) flowing foam-forming fluid through the dispenser; (c) dispensing the foam-forming fluid from the dispenser onto a moving bottom belt of a bottom or lower sheet substrate; (d) allowing the foam-forming fluid to react, as the fluid travels on the moving belt typically in a horizontal direction, to form a foam inbetween a top sheet substrate (top layer) and the bottom sheet substrate (bottom layer); (e) allowing the foam to contact the top and bottom layers, which are confined inside the double band, and to fill in the gap between the top and bottom layers, such that the foam is integrally connected to the top and bottom layers forming a panel structure comprising the foam material disposed inbetween the top and bottom layers; and (f) cutting the formed foamed panel from step (e) into predetermined discrete panel sections.

Polyurethane and/or polyisocyanurate foam panels can be produced using a continuous process or a discontinuous process. For example, a discontinuous process for the discontinuous production of panels is usually carried out using molds of defined shapes and sizes. The dimensions of the mold is usually between 3 m and 12 m in length, between 1 m and 2 m in width, and between 5 cm to 20 cm in thickness. In a discontinuous process, the reacting mixture is usually injected in the mold through injection hole(s); and then, the injection hole or holes are closed immediately after the injection. In some discontinuous processes, the mold is open to the atmosphere and the reacting mixture is distributed within the mold using a casting rake; and then, the mold is closed. Afterwards, the reacting mixture reacts to form a foam and as the foam is generated, the foaming mass fills the mold, while air is released through venting holes specifically positioned according to the geometry of the mold.

A continuous process is less flexible than the above-described discontinuous process; but the continuous process has a much lower cost per square meter of panel than the discontinuous process. In one embodiment, the continuous process consists of a multi-component dosing unit; a high-pressure mixing head; a laydown section, where the reacting mixture is homogeneously distributed over the full width of the band; and a heated moving conveyor to transport and cure the foam. The resulting cured foam product is then cut into sections of a predetermined length by a panel cutting section, where panels of a desired length are cut. Thereafter, the panels are stacked and stored to finalize the curing before the panels are to be packed. In the case of a rigid-faced DBL at the beginning of the line, the following steps/sections are also included: profiling, pre-heating and pre-treating (e.g. corona treatment and deposition of an adhesion promoting layer) of the metal sheets. Typical line speeds used in a continuous process are from 4 m/min to 15 m/min for RFDBL in one embodiment; and from 4 m/min up to 60 m/min for FFDBL. Temperatures used for processing PUR and PIR foam are different and can vary. In general, for example, the temperature of the metal sheets can vary between 20° C. and 80° C., while the temperature of the components is between 20° C. and 40° C. The mixing head is operated at a pressure of from about 110 bar to 170 bar in one embodiment; from 120 bar to 170 bar in another embodiment; and from 130 bar to 170 bar in still another embodiment.

In one general embodiment, the panel article can comprise one or more layers. In a preferred embodiment, for example, the panel article is a three-layer structure including (1) a top sheet substrate (top layer); (2) a bottom sheet substrate (bottom layer); and (3) a foam (middle layer) disposed inbetween the top and bottom layers and integrally connected to the top and bottom layers forming a panel structure. With reference to FIGS. 21-23, there is shown a panel article or member, generally indicated by numeral 140 including for example, a top facing layer 141, a bottom facing layer 142, and a middle layer of foam 143.

Some of the advantageous properties exhibited by the panel member made by the above process of the present invention can include, for example, the panel member has: (1) more homogeneous panel properties, and (2) a reduced panel density. In addition, the use of the above-described fabrication process to manufacture panel members allows a manufacturer to design a dispensing device (or distributor) with geometries which were not possible with conventional injection molding equipment and processes; and as a result, this can have a beneficial effect on distribution of the fluid passed through the dispensing device; and therefore on the homogeneity property of the resulting panel member. Furthermore, having a better distribution of foam-forming fluid also provides the manufacturer the capability of managing foam overpacking in a better way and reducing panel applied density, which in turn, has a beneficial impact on final panel cost. Foam overpacking is described as the amount of PUR/PIR foam exceeding the minimum amount of foam needed to fill the panel thickness.

One of the major applications of PUR and PIR insulation foams is in commercial buildings wherein steel sandwich panels in some geography can be used and wherein flexible-faced panels in other geography can also be used. The panel fabrication process provides sandwich panels that exhibit a combination of thermal insulation and mechanical strength leading to building efficiency. Fire retardant performance is also an important property of sandwich panels. The sandwich panels of the present invention are useful in both industrial and residential applications, and can be used, for example, as wall and roof panels, for cold stores insulation, for doors of any type and application, for windows for sliding shutters, and the like.

1. A multilayer flexible film fluid-dispensing liner member useful for manufacturing a fluid dispensing device comprising:
(a) at least one first flexible film substrate layer; and
(b) at least one second flexible film substrate layer;
wherein the first flexible film substrate layer is bonded to the second flexible film substrate layer forming a multilayer flexible film member; wherein the multilayer flexible film member has a flexibility property of from 3.6e-10 Nm to 2 Nm; and
(c) at least one duct having at least one inlet and a plurality of outlets, the at least one duct being disposed between the first and second layers for forming a path for a fluid to pass from the at least one inlet of the duct to the plurality of outlets of the duct.

2. The multilayer flexible film multilayer flexible film member of claim 1, wherein the first film substrate layer and the second film substrate layer are constructed of a heat-sealable material such that the first film substrate layer is bondable to the second film substrate layer by a heat-sealing process to form the multilayer flexible film fluid-dispensing liner member.

3. The multilayer flexible film fluid-dispensing liner member of claim 1, wherein the first film substrate layer comprises at least two film layers including (i) a first outer film layer and (ii) a second inner film layer; and wherein the second film substrate layer comprises at least two film layers including (iii) a first outer film layer and (iv) a second inner film layer; and wherein the second inner film layer (ii) of the first film substrate (a) is heat-sealed to the second inner film layer (iv) of the second film substrate (b).

4. The multilayer flexible film fluid-dispensing liner member of claim 1, including further (d) at least one middle tie layer; wherein the middle tie layer is disposed and bonded(sandwiched) inbetween the first and second substrate layers such that the first film substrate layer is bondable to the second film substrate layer via the middle tie layer to form the multilayer flexible film fluid-dispensing liner member.

5. The multilayer flexible film fluid-dispensing liner member of claim 4, wherein the middle tie layer is made of polyethylene.

6. The multilayer flexible film fluid-dispensing liner member of claim 4, wherein the middle tie layer is bonded to the first and second substrate layers by a heat-sealing process.

7. The multilayer flexible film fluid-dispensing liner member of claim 1, including further (d) at least one middle adhesive layer; wherein the middle adhesive layer is disposed and bonded(sandwiched) inbetween the first and second layers such that the first film substrate layer is bondable to the second film substrate layer via the middle adhesive layer to form the multilayer flexible film member.

8. The multilayer flexible film fluid-dispensing liner member of claim 1, including further (d) at least one middle substrate layer; wherein the middle substrate layer includes a combination of a tie layer and an adhesive layer; and wherein tie layer is bonded to the first and second substrate layers by adhering the tie layer to the first and second substrate layers with the adhesive layer.

9. The multilayer flexible film fluid-dispensing liner member of claim 1, wherein the multilayer flexible film fluid-dispensing liner member is stable and operable at a temperature of from 10° C. to 50° C.; and at a pressure of from 101325 Pa to 1621200 Pa without degradation of the multilayer flexible film fluid-dispensing liner member.

10. The multilayer flexible film fluid-dispensing liner member of claim 1, wherein each of the first film substrate layer and the second film substrate layer separately is selected from the group consisting of a metal; a plastic; a glass fiber-containing material; a mineral fiber-containing material; a cellulose-containing material; a polymer; or combinations thereof.

11. The multilayer flexible film fluid-dispensing liner member of claim 1, wherein each of the first film substrate layer and the second film substrate layer separately is a polymer material selected from the group consisting of polyethylene, linear low density polyethylene, polyethylene terephthalate, oriented polyethylene terephthalate, metalized polyethylene terephthalate, polypropylene, oriented polypropylene, biaxially oriented polypropylene, oriented polyamide/Nylon, a silicone, and a coextruded film structure including one or more the aforementioned film substrate layers.

12. The multilayer flexible film fluid-dispensing liner member of claim 11, wherein each of the first film substrate layer and the second film substrate layer separately is a two-layer film structure comprising (A) a first outer polyethylene terephthalate layer, and (B) a second inner polyethylene layer.

13. The multilayer flexible film fluid-dispensing liner member of claim 12, wherein the inner layer is made of a material with a low affinity to a fluid in contact with the inner layer.

14. The multilayer flexible film fluid-dispensing liner member of claim 13, wherein the inner layer is made of a material with a low affinity to polyurethane and/or polyisocyanurate based fluid.

15. A process for making a multilayer flexible film fluid-dispensing liner member comprising the steps of:
(I) providing (a) at least a first film substrate layer; and (b) at least a second film substrate layer; wherein the first and second substrates are constructed of a material for use with and contacting a polyurethane composition fluid;
(II) contacting at least a portion of the surface of the first film substrate layer with at least a portion of the surface of the second film substrate layer; and
(III) heating at least a portion of the first film substrate layer in contact with the second film substrate layer at a temperature of from 100° C. to 170° C. to bond at least a portion of the first film substrate layer to the second film substrate layer to form at least one duct having at least one inlet and at least one outlet, the at least one duct being disposed between the first and second substrate layers for forming a path for a fluid to pass from the at least one inlet of the duct to the at least one outlet of the duct.
